(19) United States
(12) Patent Application Publication
(10) Pub. No.: US 2012/0267112 A1
(43) Pub. Date: Oct. 25, 2012

(54) WELL SERVICE COMPOSITIONS AND METHODS

(75) Inventors: Kewei Zhang, Calgary (CA); ShanDong Cao, (US)

(73) Assignee: TRICAN WELL SERVICE LTD., Calgary, AB (CA)

(21) Appl. No.: 13/392,423

(22) PCT Filed: Sep. 3, 2010
(86) PCT No.: PCT/CA10/01370

§ 371 Date: May 18, 2012

Related U.S. Application Data
(60) Provisional application No. 61/239,599, filed on Sep. 3, 2009.

(51) Int. Cl. C09K 8/60; E21B 43/26

(52) U.S. Cl. 166/308.1; 507/219; 507/246

(57) ABSTRACT

A composition for isolating a zone in a wellbore comprising: an aqueous liquid hydrophobic solid particles, and an oil.

### FIELD

This invention relates to well service compositions and methods.

### BACKGROUND

Stimulating individual zones in subterranean formations that have multiple hydrocarbon bearing zones, often involves diverting a stimulation fluid, for example a fracturing fluid, to a targeted zone. It is common to use mechanical isolation or sand plugs to isolate the zone being stimulated from other zones in the formation.

### SUMMARY

According to a first aspect, the invention relates to a composition comprising, an aqueous liquid, hydrophobic solid particles, and an oil.

According to another aspect, the invention relates to a composition comprising an aqueous liquid, solid particles, a hydrophobizing agent, and an oil.

According to another aspect, the invention relates to a method comprising mixing a water-based fracturing fluid with proppant, a hydrophobizing agent and an oil, and pumping the fluid into the subterranean formation at a pressure sufficient to fracture the formation. The hydrophobizing agent can be selected from the group consisting of a primary amine, a secondary amine, and a tertiary amines, wherein the amine contains at least 14 carbon atoms. The amine can also contain at least 16 carbon atoms.

According to a further aspect, the invention relates to methods and compositions which can be used to isolate one or more zones in a wellbore (including vertical and horizontal wellbores) divert well service fluids such as fracturing fluids, mitigate proppant flowback after a hydraulic fracturing operation, and mitigate formation sand and/or other particles from migrating from a formation into a to a wellbore in the formation during hydrocarbon production from the formation.

According to a still further aspect, the invention relates to particles (including particles used as proppants) having surfaces which are hydrophobic are agglomerated. The particles can either be naturally hydrophobic or can be treated by one or more hydrophobizing agents to become hydrophobic. Such agglomerated particles can be used in various well service operations, including fracturing and flowback operations.

### DETAILED DESCRIPTION

In embodiments of this invention, compositions of agglomerated particles, such as sand particles, are used to isolate one or more zones in vertical as well as horizontal wells. Such compositions can also be used in other wellbore service operations where isolation of one or more zones and/or diversion of a well service fluid is required, such as in well cementing and drilling operations.

In other embodiments, compositions and methods according to the invention are used for mitigating proppant flowback after a fracturing treatment and preventing formation sand from migrating to wellbore during hydrocarbon production.

In one embodiment, a composition embodying the principles of the invention comprises: water, oil and hydrophobic particles. Suitable oils include hydrocarbon oils, wax, mineral oils, plant oils such as vegetable oils, fatty oils and silicone oils. The hydrophobic particles can be natural hydrophobic minerals including talc, molybdenite, graphite and high rank coal, or surface treated particles including resin coated particles and particles treated by hydrophobizing agents.

Hydrophobic particles useful for the invention can also comprise naturally non-hydrophobic particles which can be treated by hydrophobizing agents to render them hydrophobic. For example, sand, which is naturally hydrophilic and can be easily water wetted, can be mixed with a chemical agent, referred to as hydrophobizing agent, to make surfaces of the sand hydrophobic. For example, in one embodiment of the invention, a hydrophobizing agent can be simply mixed into a sand slurry comprising sand and water. In another embodiment of the invention, sand can first be treated by a hydrophobizing agent, dried and then used or kept for later use.

In embodiments of the invention, compositions according to the invention can be mixed on-the-fly. For example, an oil useful in compositions according to the invention can be added on-the-fly together with a suitable hydrophobizing agent. The oil can also first be blended with a hydrophobizing agent and then added as one additive during a well service operation. In another embodiment of the invention, a sand slurry containing sand and water can first be pumped into a wellbore followed by the pumping of a mixture of a hydrophobizing agent according to the invention and an oil, or a mixture of a hydrocarbon oil, a hydrophobizing agent according to the invention and water or other suitable common organic solvent, into the wellbore. Common organic solvents suitable for compositions of the invention, include alcohols, ethers, and polyhydroxyl compounds such as glycerine.

In another embodiment of the invention, a suitable amount of oil is first pumped into a wellbore and followed by the pumping of a slurry containing water and sand hydrophobically treated according to the invention or a mixture of water, a hydrophobizing agent according to the invention and sand, into the wellbore. In the case where there are oils in the wellbore already, there may be no need to add further oil into the wellbore. As mentioned herein, sand can be treated to become hydrophobic for the use in the invention. Besides sand, other particles can also be treated by hydrophobizing agents according to the invention to render surfaces of the particles hydrophobic. Suitable particles include ceramics, coal, glass beads, organic shells and resin coated particles. In some embodiments of the invention, the size of the particles ranges from approximately 75 to 2000 μm. Mixtures of different particles and/or particles of different sizes can be used in order, for example, to modify the permeability of sand plugs.

In addition to use as sand plugs in sand plug applications, methods and compositions embodying the principles of the invention can also be used in other applications including mitigating proppant flowback after a fracturing treatment or preventing formation sand/particles from flowing into a wellbore during production of the well. For example, in hydraulic fracturing, a hydrophobizing agent, and an oil, for example a hydrocarbon oil, can be added into a water-based fluid containing proppant such as sand or ceramic particles. The hydrophobizing agent and the oil can be applied throughout the entire proppant stage or during a portion of the proppant stage, such as the last portion of the proppant stage, i.e., tail-in.

In other embodiments of the invention, after proppant is pumped into a formation, a fluid containing a hydrophobizing agent and an oil is pumped into the formation to contact the proppant already in the formation.

Fracturing fluids suitable for use in methods according to the invention include water-based fracturing fluids such as water-based fluids containing polysaccharide polymers, including guar gum, hydroxypropyl gum, carboxymethyl hydroxypropyl guar (CMHPG), carboxymethyl cellulose (CMC) and carboxymethyl hydroxyethyl cellulose (CMHEC). The polysaccharide polymers can be added into the fluids directly (for example as a liner fluid) or the polymers can be further cross-linked by a cross-linking agent such as borate or zirconium cross-linker to form cross-linked gels. Certain synthetic polymers including polyacrylic acid and polyethylene oxide based polymers can also be used to gel fluids according to the invention.

Compositions and methods according to the invention can also be used for water fracturing, in which straight water or water containing a very small amount of friction reducer, commonly called slick water, is used as a fracturing fluid. The friction reducer is normally a polyacrylamide or polyethylene oxide based polymer. In such embodiments, the hydrophobizing agent and oil can be added into the fluid separately, on-the-fly, batch mixed, or premixed before being added into the fracturing fluid, either on-the-fly or batch mixed.

When fluids according to the invention are used in a well containing enough liquid hydrocarbons, there may be no need to add additional oils. Sand and/or other non naturally hydrophobic particles as disclosed herein can first be hydrophobized, dried and then used to make a hydrophobic fluid composition which can then be pumped into a wellbore and subsequently into fractures.

In another embodiment of the invention, water containing pre-treated particles (pre-treated with an hydrophobizing agent according to the invention to render surfaces of the particles hydrophobic) can be pumped into a formation containing a sufficient amount of liquid hydrocarbons. In all such operations, a gas such as nitrogen, carbon dioxide or air can be mixed into fluid compositions according to the invention.

Besides controlling proppant flowback in hydraulic fracturing treatments, compositions embodying the principles of invention are also useful in reducing formation sand production during well production. Sand production can increase substantially when wells begin to produce water. Formation sand is normally hydrophilic, or water-wet, and therefore is easily entrained by a flowing water phase. Compositions embodying the principles of the invention can be used to treat a formation to reduce formation sand production. For example, a fluid, preferably an aqueous fluid, containing a suitable amount of the hydrophobizing agent can be injected into an unconsolidated formation.

Without being bound by theory, after particles according to the invention become hydrophobic, they tend to aggregate together. The hydrophobic surfaces also tend reduce the dragging force exerted by the aqueous fluid on particles in fluid making them more difficult to be entrained. If the water phase contains a sufficient certain amount of oil, the hydrophobic aggregation between the particles can be further enhanced.

In another embodiment of the invention, a fluid containing a hydrophobizing agent according to the invention can first be injected into a poorly consolidated formation, followed by injection of a small volume of oil or a fluid containing oil. A suitable amount of oil is an amount that promotes aggregation of hydrophobic particles. In a further embodiment, a fluid containing both a hydrophobizing agent and an oil can be injected into a targeted zone. In all these embodiments, a gas such as nitrogen, carbon dioxide or air can be mixed into fluids according to the invention.

There are various types of hydrophobizing agents, which can be used in the invention are set out below. For example, organosilicon compounds including organosiloxane, organosilane, fluoro-organosiloxane and fluoro-organosilane can be used to render surfaces hydrophobic. Examples of such compounds include those disclosed in U.S. Pat. Nos. 4,537,595; 5,240,760; 5,798,144; 6,323,268; 6,403,163; 6,524,597 and 6,830,811 which are incorporated herein by reference.

Organosilanes are compounds containing silicon to carbon bonds. Organosiloxanes are compounds containing Si—O—Si bonds. Polysiloxanes are compounds in which the elements silicon and oxygen alternate in the molecular skeleton, i.e., Si—O—Si bonds are repeated. The simplest polysiloxanes are polydimethylsiloxanes. Organosilanes and Organosiloxanes can be used in compositions and methods of the invention to promote aggregation of particles.

Polysiloxane compounds can be modified by various organic substitutes having different numbers of carbons, which may contain N, S, or P moieties that impart desired characteristics. For example, cationic polysiloxanes are compounds in which one or more organic cationic groups are attached to the polysiloxane chain, either at the middle or the end. Normally the organic cationic group may also contain a hydroxyl group or other functional groups containing N, P or O. Perhaps, the most common organic cationic groups are alkyl amine derivatives including primary, secondary, tertiary and quaternary amines. For example, quaternary polysiloxanes include mono- as well as, di-quaternary polysiloxanes, imidazoline quaternary polysiloxanes and carboxy quaternary polysiloxanes.

Similarly, polysiloxanes suitable as a hydrophobizing agent for the invention can be modified by organic amphoteric groups, where one or more organic amphoteric groups are attached to the polysiloxane chain, either at the middle or the end, and include betaine polysiloxanes and phosphobetaine polysiloxanes.

Similarly, polysiloxanes suitable as a hydrophobizing agent for the invention can be modified by organic anionic groups, where one or more organic anionic groups are attached to the polysiloxane chain, either at the middle or the end, including sulfate polysiloxanes, phosphate polysiloxanes, carboxylate polysiloxanes, sulfonate polysiloxanes, thiosulfate polysiloxanes. The organosiloxane compounds also include alkylsiloxanes including hex amethylcyclotrisiloxane, octamethylcyclotetrasiloxane, decamethylcyclopentasiloxane, hexamethyldisiloxane, hexaethyldisiloxane, 1,3-divinyl-1,1,3,3-tetramethyldisiloxane, octamethyltrisiloxane, decamethyltetrasiloxane.

The selection of a hydrophobizing agent from those disclosed herein for compositions according to the invention depends on several factors. Among them, surface properties of the particles being treated to become hydrophobic especially their surface charge, are important.

Organosilane compounds according to the invention include alkylchlorosilane, for example methyltrichlorosilane, dimethyldichlorosilane, trimethylchlorosilane, octadecyltrichlorosilane; alkyl-alkoxysilane compounds, for example methyl-, propyl-, isobutyl- and octyltrialkoxysilanes, and fluoro-organosilane compounds, for example, 2-(n-perfluoro-octyl)-ethyltriethoxysilane, and perfluoro-octyldimethyl chlorosilane.

Other types of chemical compounds, which are not organosilicon compounds, which can be used to render surfaces of a particulate hydrophobic are certain fluoro-substituted compounds, for example certain fluoro-organic compounds including cationic fluoro-organic compounds, which can also be used a hydrophobizing agent for compositions and methods of the invention.

Further information regarding organosilicon compounds can be found in Silicone Surfactants (Randal M. Hill, 1999) and the references therein, and in U.S. Pat. Nos. 4,046,795; 4,537,595; 4,564,456; 4,689,085; 4,960,845; 5,098,979; 5,149,765; 5,209,775; 5,240,760; 5,256,805; 5,359,104; 6,132,638 and 6,830,811 and Canadian Patent No. 2,213,168 which are incorporated herein by reference.

Among the organosilanes which are useful for the invention are those which can be represented by the formula

RₙSiX(₄₋ₙ) (I)

wherein R is an organic radical having 1-50 carbon atoms that may posses functionality containing N, S, or P moieties that imparts desired characteristics, X is a halogen, alkoxy, acyloxy or amine and n has a value of 0-3. Examples of organosilanes according to formula (I) above include:
CH₃SiCl₃, CH₃CH₂SiCl₃, (CH₃)₂SiCl₂, (CH₃CH₂)₂SiCl₂, (C₆H₅)₂SiCl₂,
(C₆H₅)SiCl₃, (CH₃)₃SiCl, CH₃HSiCl₂, (CH₃)₂HSiCl, CH₃SiBr₃,
(C₆H₅)SiBr₃, (CH₃)₂SiBr₂, (CH₃CH₂)₂SiBr₂, (C₆H₅)₂SiBr₂, (CH₃)₃SiBr, CH₃HSiBr₂, (CH₃)₂HSiBr, Si(OCH₃)₄, CH₃Si(OCH₃)₃, CH₃Si(OCH₂CH₃)₃, CH₃Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHCH₂Si(OCH₃)₃, (CH₃)₂Si(OCH₃)₂, (CH₂═CH)Si(CH₃)₂Cl, (CH₃)₂Si(OCH₂CH₃)₂, (CH₃)₂Si(OCH₂CH₂CH₃)₂, (CH₃)₂Si[O(CH₂)₃CH₃]₂, (CH₃CH₂)₂Si(OCH₂CH₃)₂, (C₆H₅)₂Si(OCH₃)₂, (C₆H₅CH₂)₂Si(OCH₃)₂, (C₆H₅)₂Si(OCH₂CH₃)₂, (CH₂═CH₂)Si(OCH₃)₂, (CH₂═CHCH₂)₂Si(OCH₃)₂, (CH₃)₃SiOCH₃, CH₃HSi(OCH₃)₂, (CH₃)₂HSi(OCH₃), CH₃Si(OCH₂CH₂CH₃)₃, CH₂═CHCH₂Si(OCH₂CH₂OCH₃)₂, (C₆H₅)₂Si(OCH₂CH₂OCH₃)₂, (CH₃)₂Si(OCH₂CH₂OCH₃)₂, (CH₂═CH₂)₂Si(OCH₂CH₂OCH₃)₂, (CH₂═CHCH₂)₂Si(OCH₂CH₂OCH₃)₂, (C₆H₅)₂Si(OCH₂CH₂OCH₃)₂, CH₃Si(CH₃COO)₃, 3-aminotriethoxysilane, methyldiethylchlorosilane, butyltrichlorosilane, diphenyldichlorosilane, vinyl trichlorosilane, methyltrimethoxysilane, vinyltriethoxysilane, vinyltris(methoxyethoxy)silane, methacryloxypropyltrimethoxysilane, glycidoxypropyltrimethoxysilane, aminopropyltriethoxysilane, divinyldi-2-methoxysilane, ethyltributoxysilane, isobutyltrimethoxysilane, hexyltrimethoxysilane, n-octyltriethoxysilane, dihexyldimethoxysilane, octadecyltrichlorosilane, octadecyltrimethoxysilane, octadecyldimethylchlorosilane, octadecyldimethylmethoxysilane and quaternary ammonium silanes including 3-(trimethoxysilyl)propyldimethyloctadecyl ammonium chloride, 3-(trimethoxysilyl)propyldimethyloctadecyl ammonium bromide, 3-(trimethylethoxysilylpropyl)didecylmethyl ammonium chloride, triethoxysilyl soyapropyl dimonium chloride, 3-(trimethylethoxysilylpropyl)didecylmethyl ammonium bromide, 3-(trimethylethoxysilylpropyl)didecylmethyl ammonium bromide, triethoxysilyl soyapropyl dimonium bromide, (CH₃O)₃Si(CH₂)₃P⁺(C₆H₅)₃Cl, (CH₃O)₃Si(CH₂)₃P⁺(C₆H₅)₃Br—, (CH₃O)₃Si(CH₂)₃P⁺(CH₃)₃Cl⁻, (CH₃O)₃Si(CH₂)₃P⁺(C₆H₁₃)₃Cl⁻, (CH₃O)₃Si(CH₂)₃N⁺(CH₃)₂C₄H₉Cl, (CH₃O)₃Si(CH₂)₃N⁺(CH₃)₂CH₂C₆H₅Cl⁻, (CH₃O)₃Si(CH₂)₃N⁺(CH₃)₂CH₂CH₂OHCl⁻, (CH₃O)₃Si(CH₂)₃N⁺(C₂H₅)₃Cl⁻, (C₂H₅O)₃Si(CH₂)₃N⁺(CH₃)₂C₁₈H₃₇Cl⁻.

Other organosiloxane compounds which are useful for the invention are, polysiloxanes modified with organic amphoteric or cationic groups including organic betaine polysiloxanes and organic amine polysiloxanes where the amine group can be primary, secondary, tertiary and quaternary amines are examples. One type of betaine polysiloxane or cationic polysiloxane suitable for the invention is represented by the formula

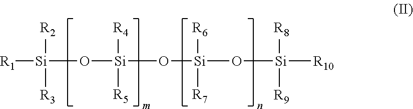

wherein each of the groups R₁ to R₆, and R₈ to R₁₀ represents an alkyl containing 1-6 carbon atoms, typically a methyl group, R₇ represents an organic betaine group for betaine polysiloxane, or an organic quaternary group for quaternary polysiloxane, and have different numbers of carbon atoms, and may contain a hydroxyl group or other functional groups containing N, P or S, and m and n are from 1 to 200. For example, one type of quaternary polysiloxane suitable for the invention is when R₇ is represented by the group

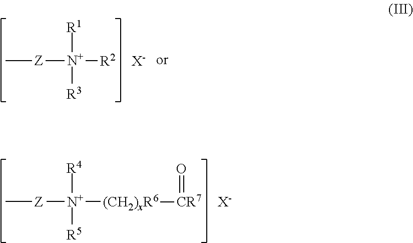

wherein R¹, R², R³ are alkyl groups with 1 to 22 carbon atoms or alkenyl groups with 2 to 22 carbon atoms. R⁴, R⁵, R⁷ are alkyl groups with 1 to 22 carbon atoms or alkenyl groups with 2 to 22 carbon atoms; R⁶ is —O— or the NR⁸ group, R⁸ being an alkyl or hydroxyalkyl group with 1 to 4 carbon atoms or a hydrogen group; Z is a bivalent hydrocarbon group with at least 4 carbon atoms, which may have a hydroxyl group and may be interrupted by an oxygen atom, an amino group or an amide group; x is 2 to 4; The R¹, R², R³, R⁴, R⁵, R⁷ may be the same or the different, and X— is an inorganic or organic anion including Cl⁻ and CH₃COO⁻. Examples of organic quaternary groups include [R—N⁺(CH₃)₂—CH₂CH(OH)CH₂—O—(CH₂)₃—](CH₃COO⁻), wherein R is an alkyl group containing from 1-22 carbons or an benzyl radical and CH₃COO⁻ an anion. Examples of organic betaines suitable for the invention include —(CH₂)₃—O—CH₂CH(OH)(CH₂)—N⁺(CH₃)₂CH₂COO⁻. Such compounds are commercial available. Betaine polysiloxane copolyol is one example of such betaines. It should be understood that cationic polysiloxanes suitable for the invention include compounds represented by formula (II), wherein R₇ represents other organic amine derivatives including organic primary, secondary and tertiary amines or other cationic groups.

Other examples of organo-modified polysiloxanes suitable for the invention include di-betaine polysiloxanes and di-quaternary polysiloxanes, which can be represented by the formula

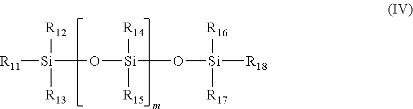

wherein the groups R₁₂ to R₁₇ each represents an alkyl containing 1-6 carbon atoms, typically a methyl group, both R₁₁ and R₁₈ group represent an organic betaine group for di-betaine polysiloxanes or an organic quaternary group for di-quaternary, and have different numbers of carbon atoms and may contain a hydroxyl group or other functional groups containing N, P or S, and m is from 1 to 200. For example, one type of di-quaternary polysiloxanes suitable for the invention is when R₁₁ and R₁₈ are represented by the group

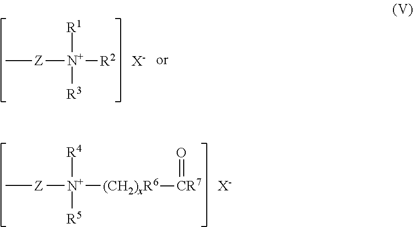

wherein R¹, R², R³, R⁴, R⁵, R⁶, R⁷, Z, X⁻ and x are the same as defined above.

Cationic polysiloxanes suitable for the invention include compounds represented by formula (IV), wherein R₁₁ and R₁₈ represents other organic amine derivatives including organic primary, secondary, tertiary amines and other organic cationic groups. Furthermore there are different mono- and di-quaternary polysiloxanes, mono- and di-betaine polysiloxanes and other organo-modified polysiloxane compounds which can be used to render solid surfaces hydrophobic and are useful as hydrophobizing agents in the present invention. These compounds are widely used in personal care and other products, for example as discussed in U.S. Pat. Nos. 4,054,161; 4,654,161; 4,891,166; 4,898,957; 4,933,327; 5,166,297; 5,235,082; 5,306,434; 5,474,835; 5,616,758; 5,798,144; 6,277,361; 6,482,969; 6,323,268 and 6,696,052 which are incorporated herein by reference.

Other examples of organosilicon compounds which can be used as hydrophobizing agents in the compositions of the present invention are fluoro-organosilane or fluoro-organosiloxane compounds in which at least part of the organic radicals in the silane or siloxane compounds are fluorinated. Suitable examples are fluorinated chlorosilanes or fluorinated alkoxysilanes including 2(n-perfluoro-octyl)ethyltriethoxysilane, perfluoro-octyldimethylchlorosilane, (CF₃CH₂CH₂)₂Si(OCH₃)₂, CF₃CH₂CH₂Si(OCH₃)₃, (CF₃CH₂CH₂)₂Si(OCH₂CH₂OCH₃)₂ and CF₃CH₂CH₂Si(OCH₂CH₂OCH₃)₃ and (CH₃O)₃Si(CH₂)₃N±(CH₃)₂(CH₂)₃NHC(O)(CF₂)₆CF₃Cl⁻. Other compounds which can be used, are fluoro-substituted compounds, which are not organic silicon compounds, for example, certain fluoro-organic compounds.

Another example of hydrophobizing agents useful for the invention, denoted here as Amine Hydrophobizing agent, are long carbon chain hydrocarbon amines (i.e., containing no silicon or fluoro-based groups in the molecules) containing at least fourteen, preferably at least sixteen carbon atoms, including simple primary, and secondary amines and tertiary amines, primary ether amines, diamines, polyamines, and ether diamines, stearyl amines, tallow amines, condensates of amine or alkanolamine with fatty acid or fatty acid ester, condensates of hydroxyethylethylenddiamines. Examples include the condensate of diethylenetetraamine and tall oil fatty acid, tetradecyloxypropyl amine, octadecyl/hexadecyloxypropyl amine, hexadecyl-1,3-propanediamine, tallow-1,3-propanediamine, hexadecyl amine, tallow amine, soyaalkylamine, erucyl amine, hydrogenated erucyl amine, ethoxylated erucyl amine, rapeseed amine, hydrogenated rapeseed amine, ethoxylated rapeseed amine, ethoxylated oleylamine, hydrogenated oleylamine, ethoxylated hexadecyl amine, octadecylamine, ethoxylated octadecylamine, ditallowamine, hydrogenated soyaalkylamine, amine, hydrogenated tallow amine, dioctadecylamine, ethoxylated (2) tallowalkylamine, for example Ethomeen T/12 or ethoxylated (2) soyaalkylamine, for example, Ethomeen S/12, or oleyl amine, for example, Armenn OL, or dicocoalkalamine, for example Armeen 2C from Akzo Nobel Inc., and the condensate of an excess of fatty acids with diethanolamine. Alkanol amines with short carbon chains, such as C₁₋₆ alkanol amines, or short carbon chain amine such as hexylamine can also be combined with long carbon chain amines. Also mixtures of different amines or mixtures of amines with amide, for example, lauric amide can be used.

In an embodiment of the invention, an amine hydrophobizing agent is added into an aqueous slurry containing mineral and silica particles, and render the silica particles hydrophobic. As a result, the silica particles become buoyant and float to the top or near the top of the slurry, where they are removed from the slurry. An oil can be added to promote buoyancy. Amine hydrophobization agents useful for compositions and methods of the invention can be selected from those found in, for example, U.S. Pat. Nos. 2,173,909; 2,206,928; 2,278,060 2,312,387; 2,322,201; 2,710,856; 3,596,763; 4,234,414; 4,276,156; 4,287,052; 4,450,070; 4,474,619; 5,507,394 and 5,124,028 and non-patent publications, for example, S. Takeda and S. Usui in Colloid and Surfaces, 29, 221-232, 1988; M. J. Rosen, Surfactants and Interfacial Phenomena (Second Edition) p 17-18; and J. L. Scott and R. W. Smith in Minerals Engineering, Vol. 4, No. 2, 141-150, 1991. Amine hydrophobizing agents can be selected by conducting routine testing and/or based on the characteristics of the amines available in text books, scientific/technology publications and patents, to achieve desired properties, such as degree of agglomeration and/or buoyancy of particles and particle slurries according to the invention.

In other embodiments of the invention, one or more hydrophobizing agents can be used together in compositions according to the invention. For example, cationic polysiloxanes can be used together with amines, for example, ethoxylated tallowalkalamines. When a fluid composition according to the invention also contains other additives such as salts, alcohols, ethers or different surfactants, the additives should be compatible with the hydrophobizing agent(s), for example, forming no precipitation or reducing the surface (interfacial) tension significantly. Very low surface (interface) tension may reduce particle agglomeration. Polyhydroxyl containing compounds such as glycerine, sorbitol or mannitol may also be included in fluids according to the invention.

The inventor understands that the strength of particle aggregation according to the invention depends on the contact angle formed between an oil drop and a particle surface in water as well as on the solid/water interfacial tension. The inventor also understands that the strength of particle aggregation also depends on the amount of oil used for the aggregation. The amount of hydrophobizing agent and oil used in fluids and composition according to the invention depend to a large extent on the concentration of the particles, as well as the fluid used. In general, more hydrophobizing agent and oil are required when particle concentration is high. For example, in a fracturing operation for proppant flowback control where the fracturing fluid is guar gelled by borate, the amount of oil should be more than 4 L/m³, or preferably more than 6 L/m³ of the total fluid volume, while when slick water is used as the fracturing fluid, the amount of oil required is relatively less, at least 2.5 L/m³ and preferably at least 5 L/m³.

The following are non-limiting examples of fluid compositions and methods embodying the principles of the present invention.

### Example 1

25 g of 40/70 US mesh frac sand is added into 100 ml of water, then adding 0.2 ml of a solution containing 20 vol % Tegopren 6924, a di-quaternary polydimethylsiloxane from Degussa Corp., and 80 vol % of ethylene glycol mono-butyl ether, and 2 ml of diesel. After being vigorously shaken, sands clump together forming strong bridge between sand grains and move together as one mass when tilted. In the Reference sample containing only water and sands, there is no sand clump and sand grains move individually when tilted.

### Example 2

25 g of 40/70 US mesh frac sand is added into 100 ml of water, then adding 1.5 ml of solution containing 95% of diesel and 5% of an amino-polydimethylsiloxane, a polysiloxane modified with amino groups. After being vigorously shaken, sands clump together forming strong bridge between sand grains and move together as one mass when tilted. In the Reference sample containing only water and sands, there is no sand clump and sand grains move individually when tilted.

### Example 3

0.75 ml of guar slurry (containing about 50% of guar gum) is added into 150 ml water under stirring for about 5 minutes for guar to be fully hydrated. 2.25 ml of the Blend is added into the hydrated guar solution under stirring. The Blend contains 4.5% of amino-polydimethylsiloxane, 19% of Ethomeen T 12, 15% of diesel, 31% of MS-6, a mutual solvent, and 30.5% of water. Immediately afterwards, 150 grams of 20/40 frac sands, 0.6 ml of borate cross-linker and peroxide breaker are added under stirring. After the cross-linker is added the solution turns to basic (pH is about 9) and within 20 seconds, guar gum is fully cross-linked forming strong gel. Same procedure is followed for the Reference sample except the gel does not contain the Blend. After the gels are fully broken few hours later at 55° C., it is visually observed that in the test sample containing the Blend sands clump together forming strong bridge between sand grains and moving together as one mass when tilted, while in the Reference sample, there is no sand clump and the sand grains move individually when tilted.

### Example 4

100 g of 20/40 US mesh frac sand is added into 100 ml of water, then adding 1.5 ml of solution containing 80% of diesel and 20% of Ethomeen S 12, an ethoxylated (2) soyaalkalamine from Akzo Noble Inc. After being vigorously shaken, sands clump together forming strong bridge between sand grains and move together as one mass when tilted. In the Reference sample containing only water and sands, there is no sand clump and sand grains move individually when tilted.

### Example 5

100 g of 20/40 US mesh frac sand is added into 100 ml of water, then adding 1.5 ml of solution containing 80% of diesel and 20% of Ethomeen T 12, an ethoxylated (2) tallowalkalamine from Akzo Noble Inc. After being vigorously shaken, sands clump together forming strong bridge between sand grains and move together as one mass when tilted. In the Reference sample containing only water and sands, there is no sand clump and sand grains move individually when tilted.

1. A composition for isolating a zone in a wellbore comprising:
an aqueous liquid
hydrophobic solid particles, and
an oil.

2. A composition for isolating a zone in a wellbore comprising:
an aqueous liquid,
solid particles,
a hydrophobizing agent, and
an oil.

3. The composition of claim 2, wherein the hydrophobizing agent is selected from the group consisting of an organosilane, a siloxane, a fluoro-silane, a fluoro-siloxane, a fluoro-compound and an hydrocarbon amine containing at least 14 carbon atoms.

4. The composition of claim 2, wherein the hydrophobizing agent is an organosilane compound.

5. The composition of claim 2, wherein the hydrophobizing agent is an organosiloxane compound.

6. The composition of claim 2, wherein the hydrophobizing agent is an organosiloxane compound modified with cationic or amphoteric groups.

7. The composition of claim 2, wherein the hydrophobizing agent is an hydrocarbon amine containing at least 16 carbon atoms.

8. A method of fracturing a subterranean formation comprising
mixing a water-based fracturing fluid with proppant, a hydrophobizing agent and an oil, and pumping the fluid into the subterranean formation at a pressure sufficient to fracture the formation,
wherein the hydrophobizing agent is selected from the group consisting of a primary amine, a secondary amine, a tertiary amine, and a polyamine, wherein the amine contains at least 14 carbon atoms.

9. The method of claim 8, wherein the amine contains at least 16 carbon atoms.

10. The method of claim 8, wherein the amine is selected from the group consisting the condensates of amine or alkanolamine with fatty acid or fatty acid ester, condensate of hydroxyethylethylenddiamines, condensates of diethylenetetraamine and fatty acid, stearyl amine, tetradecyloxypropyl amine, octadecyl/hexadecyloxypropyl amine, hexadecyl-1,3-propanediamine, tallow-1,3-propanediamine, hexadecyl amine, tallow amine, soyaalkylamine, erucyl amine, hydrogenated erucyl amine, ethoxylated erucyl amine, rapeseed amine, hydrogenated rapeseed amine, ethoxylated rapeseed amine, ethoxylated oleylamine, hydrogenated oleylamine, ethoxylated hexadecyl amine, octadecylamine, ethoxylated octadecylamine, ditallowamine, hydrogenated tallow amine, dioctadecylamine, ethoxylated (2) tallowalkylamine, ethoxylated (2) soyaalkylamine, oleyl amine, hydrogenated soyaalkylamine, hydrogenated oleylamine and dicocoalkylamine.

11. The method of claim 8, wherein the amine is selected from the group consisting of tallow amine, soyaalkylamine, ethoxylated (2) tallowalkylamine, ethoxylated (2) soyaalkylamine, oleylamine, ethoxylated oleylamine, ethoxylated hexadecyl amine, hexadecyl amine, octadecylamine, ethoxylated octadecylamine, erucyl amine, hydrogenated erucyl amine, ethoxylated erucyl amine, rapeseed amine, hydrogenated rapeseed amine, ethoxylated rapeseed amine, hydrogenated tallow amine, hydrogenated soyaalkylamine and hydrogenated oleylamine.

12. The method of claim 8, wherein the fracturing fluid is a water based fracturing fluid comprising a polysaccharide polymer and water.

13. The method of claim 8, wherein the fracturing fluid is water based fracturing fluid comprising a polysaccharide polymer, water and a borate cross-linker.

14. The method of claim 8, wherein the fracturing fluid is water.

15. The method of claim 14, wherein the fracturing fluid further comprises a friction reducer.

16. A method of reducing formation sand production in a subterranean formation comprising
mixing a fluid with a hydrophobizing agent and injecting the fluid into the formation.

17. The method of claim 16, wherein the hydrophobizing agent is selected from the group consisting of a primary amine, a secondary amine, a tertiary amine, and a polyamine, wherein the amine contains at least 14 carbon atoms.

18. The method of claim 17, wherein the fluid is a water based fluid.

19. The method of claim 18, wherein the fluid further comprises oil.

20. The method of claim 17, wherein the amine contains at least 16 carbon atoms.

21. The method of claim 17, wherein the amine is selected from the group consisting of condensates of amine or alkanolamine with fatty acid or fatty acid ester, condensate of hydroxyethylethylenddiamines, condensates of diethylenetetraamine and fatty acid, stearyl amine, tetradecyloxypropyl amine, octadecyl/hexadecyloxypropyl amine, hexadecyl-1,3-propanediamine, tallow-1,3-propanediamine, hexadecyl amine, tallow amine, soyaalkylamine, erucyl amine, hydrogenated erucyl amine, ethoxylated erucyl amine, rapeseed amine, hydrogenated rapeseed amine, ethoxylated rapeseed amine, ethoxylated oleylamine, hydrogenated oleylamine, ethoxylated hexadecyl amine, octadecylamine, ethoxylated octadecylamine, ditallowamine, hydrogenated tallow amine, dioctadecylamine, ethoxylated (2) tallowalkylamine, ethoxylated (2) soyaalkylamine, oleyl amine, hydrogenated soyaalkylamine, hydrogenated oleylamine and dicocoalkylamine.

22. The method of claim 16, wherein the amine is selected from the group consisting of tallow amine, soyaalkylamine, ethoxylated (2) tallowalkylamine, ethoxylated (2) soyaalkylamine, oleylamine, ethoxylated oleylamine, ethoxylated hexadecyl amine, hexadecyl amine, octadecylamine, ethoxylated octadecylamine, erucyl amine, hydrogenated erucyl amine, ethoxylated erucyl amine, rapeseed amine, hydrogenated rapeseed amine, ethoxylated rapeseed amine, hydrogenated tallow amine, hydrogenated soyaalkylamine and hydrogenated oleylamine.
